(19) United States
(12) Patent Application Publication
(10) Pub. No.: US 2025/0214142 A1
(43) Pub. Date: Jul. 3, 2025

(54) A METHOD OF DESKTOP THREE-DIMENSIONAL METAL PRINTING WITH LESSER LEAD TIME

(71) Applicant: THINKMETAL PRIVATE LIMITED, Kancheepuram (IN)

(72) Inventors: Sabyasachi GHOSH, Kancheepuram (IN); Arushi SHARMA, Kancheepuram (IN)

(21) Appl. No.: 18/850,074

(22) PCT Filed: Mar. 27, 2023
(86) PCT No.: PCT/IB2023/053027

§ 371 Date: Sep. 24, 2024

(30) Foreign Application Priority Data
Mar. 27, 2022 (IN) 202241013539

(51) Int. Cl. B22F 10/18; B22F 10/80; B22F 12/58; B33Y 10/00; B33Y 30/00; B33Y 50/00; B33Y 70/10

(52) U.S. Cl. CPC B22F 10/18; B22F 10/80; B22F 12/58; B22F 2999/00; B33Y 10/00; B33Y 30/00; B33Y 50/00; B33Y 70/10

(57) ABSTRACT

The present invention provides a novel 3D printing process for metal printers that aims to reduce the process lead time while using compact equipment and conserving resources. The process includes feedstock preparation, printing, debinding, sintering, and heat treatment. By integrating debinding, sintering, and heat treatment into a single cycle, the process significantly reduces the lead time by hours, making it a faster and more efficient method for producing 3D metal parts. The novel feedstock mixture, including but not limited to metallic powder, reinforcement, and a binder system with lubricating agents, allows for the successful molten material extrusion hence the printing of complex parts. The integration of debinding, sintering, and heat treatment into a single cycle significantly reduces the process lead.

### FIELD OF THE INVENTION

The present invention pertains to the realm of additive manufacturing, particularly in the area of three-dimensional/3D metal printing.

### BACKGROUND AND OBJECTIVES OF THE INVENTION

Additive manufacturing is a process of creating three-dimensional objects by joining materials, rather than removing them as in subtractive manufacturing. One example of additive manufacturing is 3D metal printing, which involves depositing material layer by layer to form a 3D structure.

Desktop 3D metal printing is a valuable tool for rapid prototyping and print-and-fit applications in various settings, including R&D centres, design studios, and educational institutes. Metal 3D printing also has gained significant attention in recent years. It has become increasingly popular in industries such as aerospace, medical, and automotive due to its ability to produce complex geometries, reduce material waste, and create parts with improved mechanical properties. The metal 3D printing process involves the use of a high-power energy source, such as a laser or electron beam, to melt metal powder or wire and deposit it layer by layer to form a three-dimensional structure. This process is also known as selective laser melting (SLM) or electron beam melting (EBM). One of the main advantages of metal 3D printing is the ability to create parts with complex geometries that cannot be manufactured using traditional manufacturing techniques. This enables designers to create lightweight, high-performance components that are optimized for their specific applications. Metal 3D printing also allows for the production of small batches of parts at a lower cost, which is particularly useful for niche applications.

Despite the potential benefits, metal 3D printing still faces several challenges. One of the main challenges is the high cost of the technology. The machines used for metal 3D printing are expensive, and the materials used, such as titanium and nickel-based alloys, can be costly as well. Another challenge is the low production rates. Metal 3D printing can be a slow process, as it involves depositing layer by layer to form the final structure. This makes it difficult to produce large quantities of parts quickly and efficiently. Furthermore, metal 3D printing can produce parts with poor surface quality due to the presence of residual powder or defects. Post-processing steps are necessary to remove the residual powder and improve surface quality, which can increase the lead time and cost of the process. To overcome these challenges, researchers and companies are developing new metal 3D printing methods that can improve production rates, reduce costs, and enhance part quality. Some of these methods include using multiple lasers or electron beams to increase productivity, using cheaper metal powders, and developing post-processing techniques that can reduce the time and cost of removing residual powder and improving surface quality. Overall, metal 3D printing has the potential to transform manufacturing by enabling the production of high-quality metal parts with complex geometries. While there are still challenges to overcome, the development of new metal 3D printing methods holds great promise for the future of manufacturing.

Fused Filament Fabrication (FFF) is a popular 3D printing technique that is utilized to print a wide range of materials, including metals. In the metal 3D printing process, the FFF technique uses a feedstock prepared by mixing metal powder with binders. The mixture is then extruded into filaments or rods that are subsequently melted and deposited in layers to create a metal part. This process is referred to as printing, and the part printed is referred to as the green part. Once the green part has been printed, it undergoes a debinding process, which is essential for removing the binders used in the feedstock preparation. The debinding process involves submerging the green part in a wash or a catalytic debinder to dissolve the binders. Once the binders have been removed, the green part is transformed into a brown part. The brown part then undergoes a sintering process, which is essential for achieving full-density metal parts. In the sintering process, the brown part is heated to a high temperature, causing the metal particles to fuse together, creating a fully dense metal part.

While FFF metal 3D printing has several advantages, such as being compact, inexpensive, and relatively simple compared to Selective Laser Melting (SLM) 3D printing, it has some limitations. One of the most significant limitations is the time-consuming nature of the process, which involves several steps, including feedstock preparation, printing, debinding, and sintering. Another limitation is that FFF metal 3D printing produces parts with a relatively rough surface finish compared to other metal 3D printing techniques. This is due to the nature of the process, which involves the deposition of melted filaments or rods in layers, resulting in visible layer lines on the surface of the printed part. This rough surface finish is not ideal for parts that require a smooth surface finish, such as medical implants. Furthermore, the FFF metal 3D printing process is limited in terms of the size of the parts that can be printed. The process is better suited for producing small to medium-sized parts and may not be suitable for large parts due to the limitations of the printing equipment. To overcome some of these limitations, researchers are developing new methods and materials for FFF metal 3D printing.

For example, new metal alloys with improved properties for FFF printing are being developed to create parts with enhanced mechanical properties. Additionally, post-processing techniques such as polishing and chemical treatments are being explored to improve the surface finish of FFF-printed parts. In conclusion, FFF metal 3D printing is a promising technique for producing metal parts with several advantages over other metal 3D printing techniques. However, the process has some limitations, such as its highly time-consuming nature, limited size range, and relatively rough surface finish. The present invention is directed towards providing a method and apparatus for 3D printing metal in a fast and efficient manner using compact equipment, with the goal of conserving various resources. The objective is to eliminate the multiple steps involved in the current fused filament fabrication method for metal 3D printing, which includes melting the feedstock and depositing them layer by layer, followed by debinding, sintering and post-processing, making it a time-consuming process.

### SUMMARY OF THE INVENTION

The present invention provides a novel 3D printing process for metal printers that aims to reduce the process lead time while using compact equipment and conserving resources. The process includes feedstock preparation, printing, debinding, sintering, and heat treatment. By integrating debinding, sintering, and heat treatment into a single cycle, the process significantly reduces the lead time by hours, making it a faster and more efficient method for producing 3D metal parts.

The novel composition of the feedstock mixture is a combination of but not limited to metallic powder, reinforcement, and a binder system. The metallic powder may be pure metal or metal alloy powder, while the reinforcement can be any material that enhances the final product's properties, such as but not limited to ceramic powder, nanomaterial, micromaterial, graphite powder or alloy powder. The binder system is composed of organic or inorganic binders, organic such as but not limited to thermoplastic polymers, thermosetting polymers, thermoplastic elastomers, long-chain fatty acids, and olefinic waxes, and may also contain lubricating agents. The binder system is primarily responsible for holding the metal powders together and also holding the reinforcement together to the mixture during the extrusion process. The mixture of metal powder and/or alloy metal powder and binder system is extruded with a suitable cross-section, in forms such as filaments or rods, and used by the metal 3D printer to print the desired three-dimensional geometries by depositing the molten mixture layer by layer.

The 3D-printed part is then processed in a piece of heating equipment using a suitable thermal cycle. During the thermal cycle, the binder is completely degraded and the metal powder is fully sintered in a suitable environment and heat treated in one cycle. This step eliminates the need for a separate debinding and sintering process, further reducing the lead time.

In summary, the present invention provides a fast and efficient method for producing 3D metal parts using a compact equipment setup. The novel feedstock mixture, including but not limited to metallic powder, reinforcement, and a binder system with lubricating agents, allows for the successful molten material extrusion hence the printing of complex parts. The integration of debinding, sintering, and heat treatment into a single cycle significantly reduces the process lead. The present invention aims to provide a method and apparatus for 3D printing metal in a fast and efficient manner using compact equipment, with the goal of conserving various resources.

### BRIEF DESCRIPTION OF DRAWINGS

FIG. 1A is a schematic diagram of an apparatus for three-dimensional printing metal objects via fused filament fabrication technique, wherein

0. An apparatus for forming three dimensional objects using fused filament fabrication technique,

1. Is the front panel of the apparatus,

2. Is the top panel of the apparatus,

3. Is a top transparent prrping window,

4. Is the back panel of the apparatus,

5. Is the transparent side peeping window of the apparatus,

6. Is the transparent front door of the apparatus,

7. Is the transparent front door hinge supporter of the door of the apparatus,

8. Is the door knob of the apparatus,

9. Is an interactive display unit of the apparatus,

10. Is the display mount of the apparatus;

FIG. 1B is the schematic diagram of the apparatus for three-dimensional printing metal objects via fused filament fabrication technique from the front view;

FIG. 1C is the schematic diagram of the apparatus for three-dimensional printing metal objects via fused filament fabrication technique from the side view;

FIG. 1D is a transparent schematic diagram of the apparatus for three-dimensional printing metal objects via fused filament fabrication technique, wherein

11. Is a structural pillar of the apparatus, which is an integral part of the frame,

12. Is the top mount platform, where all the machine components of the apparatus are assembled,

13. Is a wire channel through which all the apparatus wires are passing through,

14. Is the bottom plate that encloses and holds all the apparatus electronic components,

15. Is the smooth rod that facilitates movement of the bed of the apparatus in the Z,

16. Is the bed/build platform of the apparatus on which the molten primary metal material mixture is deposited,

17. Is a type of screw mechanism that facilitates movement of the bed of the apparatus in Z axes,

18. Is a power supply unit, that supplies power to the apparatus,

19. Is a controller mount,

20. Is the extruder casing of the extruder of the apparatus,

21. Is the Z end stop mount of the apparatus,

22. Is a type of nut to the screw that facilitates movement of the bed of the apparatus in Z axes,

23. Is a type of linearof bearing that supports the relative movement of the bed to the smooth rods,

24. Is a type of adjustable screw,

25. Is a stepper motor that facilitates movement of the bed of the apparatus in Z axes;

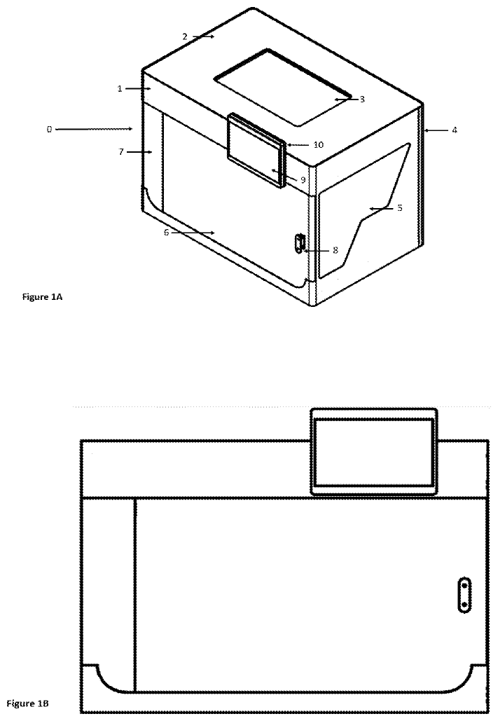

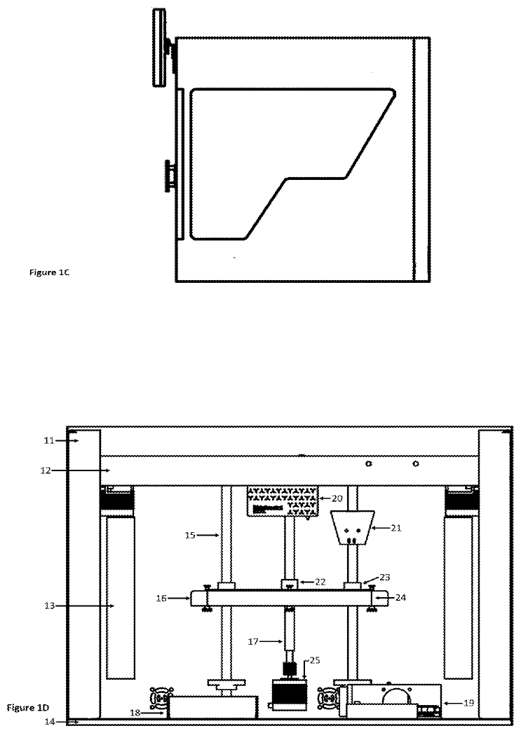

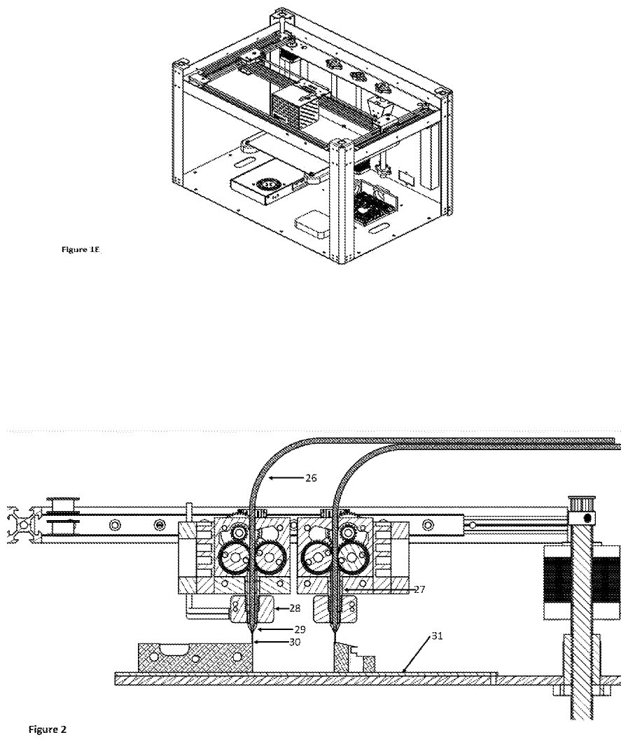

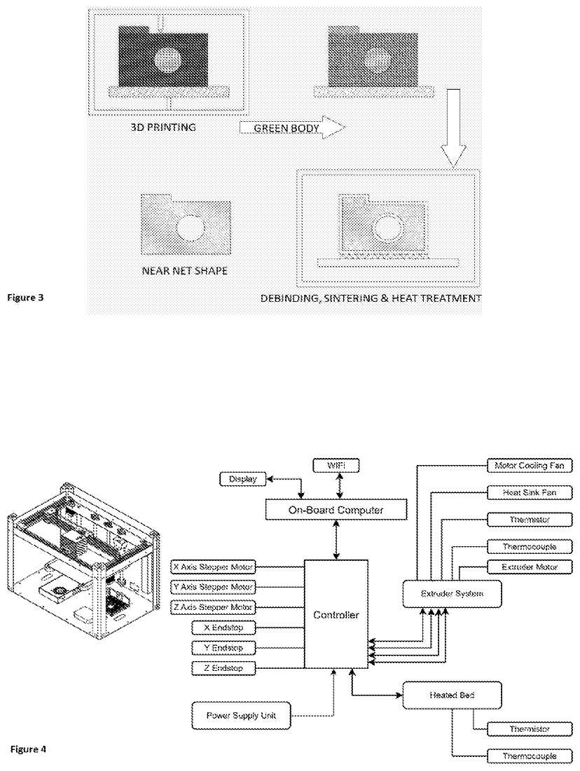

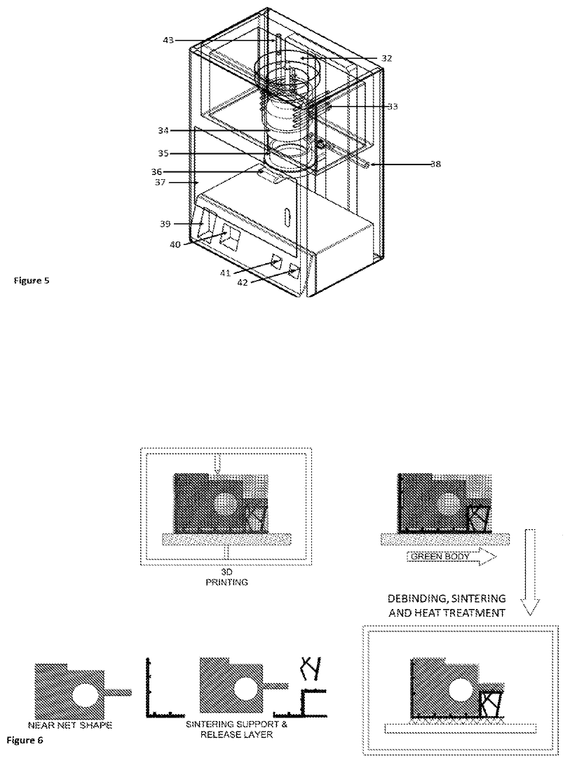

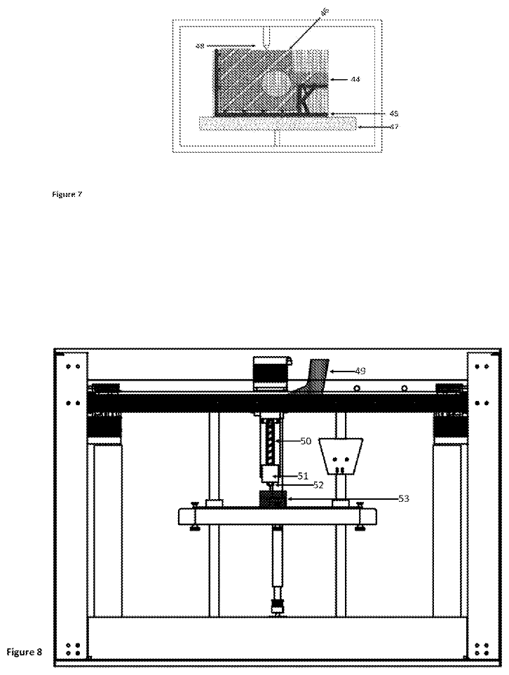

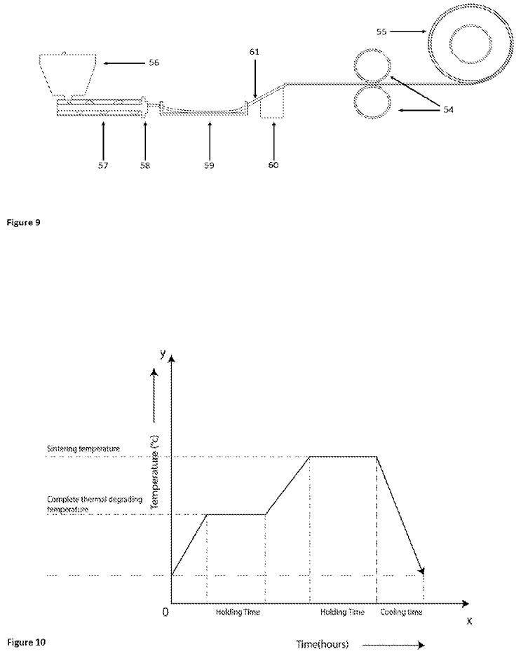

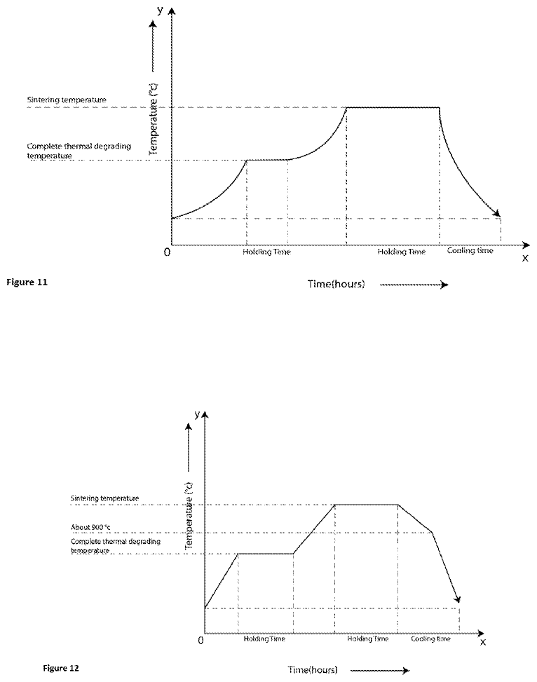

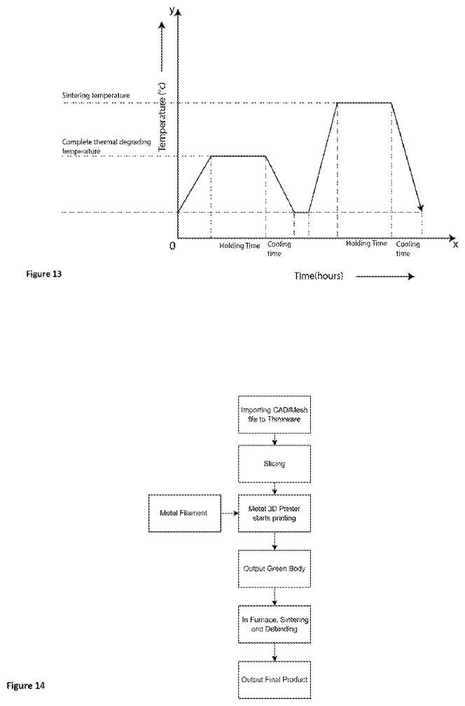

FIG. 1E is a transparent schematic diagram of the apparatus for three-dimensional printing metal objects via fused filament fabrication technique from the isometric view;

FIG. 2 is a schematic diagram of the deposition process of molten primary metal material mixture using an extruder of the three dimensional metal printing apparatus, wherein.,

26. Is the primary metal material mixture filament,

27. Is an element that is used to stop the heat from travelling through, referred to as the heat break,

28. Is an element that is used to heat the primary metal material mixture filament, also referred to as the heater block,

29. Is a nozzle of the deposition system,

30. Is the molten primary metal material mixture filament,

31. Is a buit platoform/bed which could be heated;

FIG. 3 is a schematic diagram of the three dimensional metal printing process-3d printing, debinding, sintering and heat treatment to obtain a near net shape;

FIG. 4 is a schematic diagram of the three dimensional metal printing apparatus and the logic diagram of the functioning of the three dimensional printing apparatus;

FIG. 5 is a schematic diagram of the a piece of heating equipment of the three dimensional printing apparatus, wherein,

32. Is the top covering to the heating chamber,

33. Is the side panel to the heating equipment of the three dimensional metal printing apparatus,

34. Is a bell shaped heating chamber which could be made out of but not limited to graphite and/or metal and/or ceramic,

35. Is the heating chamber bed/platform on which the green part is placed,

36. Is a lift mechanism that moves in Z direction,

37. Is a transparent front peeping door,

38. Is an inlet for gas into the heating chamber of the piece of heating equipment of the three dimensional metal printing apparatus,

39. Is a type of controller of the piece of heating equipment of the three dimensional metal printing apparatus,

40. Is an ammeter of the piece of heating equipment of the three dimensional metal printing apparatus,

41. Is a type of switch button of the piece of heating equipment of the three dimensional metal printing apparatus,

42. Is another type of switch button of the piece of heating equipment of the three dimensional metal printing apparatus,

43. Is an outlet for gas from the heating chamber of the piece of heating equipment of the three dimensional metal printing apparatus;

FIG. 6 is a schematic diagram of the three dimensional metal printing process-3d printing, debinding, sintering and heat treatment to obtain a near net shape object using a suipport structure material printing and easy removal;

FIG. 7 is a schematic diagram of the three dimensional functionally graded material printing process-FGM 3d printing, debinding, sintering and heat treatment to obtain a near net shape object using a suipport structure material printing and easy removal, wherein,

44. Is a three dimensioanlly printed Functionally Graded Material object,

45, Is a base support structure to the first layer of primary metal and/or FGM material mixture,

46. Is the seond metal material mixture that could be used to yield graded physical properties,

47. Is the built platform/bed of the three dimensional metal printing apparatus,

48. Is the material deposition system of the three dimensional metal printing apparatus;

FIG. 8 is a schematic diagram of the of the screw deposition system mounted on the gantry of the three dimensional metal printing apparatus wherein,

49. Is a hopper for of the of the screw deposition system of the three dimensional metal printing apparatus,

50. Is an extrusion screw of the deposition system of the three dimensional metal printing apparatus,

51. Is an element that is used to heat the primary metal material mixture filament, also referred to as the heater block

52. Is a nozzle of the screw deposition system,

53. Is a three dimensional metal printed part on the screw deposition three dimensional printing apparatus;

FIG. 9 is a schematic diagram of the of the filament extrusion system of the three dimensional metal printing apparatus wherein,

54. Is a roller coupled with a tensioner to manipulate the filament diameter of the filament extrusion system,

55. Is a spool roller that winds the filament onto the spool to collect the metal material mixture filament,

56. Is a hopper for the novel mixture to go in,

57. Is a type of screw filament extrusion system which could be single or co-rotating twin or counter-rotating twin screw,

58. Is the pressure die of the screw filament extrusion system,

59. Is an aqueous bath of the screw filament extrusion system,

60. Is a gauge meausuring apparatus used to determine the diamtere of the screw filament extrusion system,

61. Is the primary metal material mixture filament coming out of the filament extrusion system that could be used as a feedstock;

FIG. 10 is a schematic diagram of the of the temperature transformation curve of the heating apparatus wherein the heating rate is constant and debinding, sintering and heat treatment is done in a single process;

FIG. 11 is a schematic diagram of the of the temperature transformation curve of the heating apparatus wherein the heating rate is variable and debinding, sintering and heat treatment is done in a single process;

FIG. 12 is a schematic diagram of the of the temperature transformation curve of the heating apparatus wherein the heating rate is constant and debinding, sintering and rapid cooling done in a single process;

FIG. 13 is an additional schematic diagram of the of the temperature transformation curve of the heating apparatus wherein the heating rate is constant and debinding, sintering and heat treatment is done in a longer single cycle; and

FIG. 14 is a complete block diagram of the of the three dimensional metal printing process.

### DETAILED DESCRIPTION OF THE PREFERRED EMBODIMENTS

Conventionally, Fused Filament Fabrication (FFF), also known as Fused Deposition Modeling (FDM), is a popular 3D printing technology used for creating parts and prototypes using a range of materials, including metals. While FFF technology was initially developed for printing with thermoplastics, advancements in material science have allowed for the development of metal-infused filaments, which can be used to print metal parts through the FFF process.

The FFF process involves the extrusion of a filament, typically made of a thermoplastic base material mixed with metal powders, through a heated nozzle. The filament is melted in the nozzle and then deposited onto the build platform layer by layer to create the desired 3D object. The nozzle moves along a predetermined path, controlled by software, to deposit the material in the correct locations, creating a solid object. The process of metal 3D printing through FFF technology begins with the selection of the appropriate metal-infused filament. These filaments are typically composed of binder material, mixed with metal powders, such as copper, aluminium, or stainless steel. The metal powders are typically fine particles, with a size range of around 5-50 micrometres, which are mixed with the binder material in a precise ratio to achieve the desired properties and print quality.

Once the filament is loaded into the 3D printer, the printing process begins. The heated nozzle melts the filament as it is extruded, allowing it to flow smoothly and evenly onto the build platform. The print head moves back and forth along the X and Y axes, while the build platform or the print bed moves up and down along the Z axis, depositing the material in the selective locations to build up the object layer by layer. After the object is fully 3D printed, it undergoes post-processing steps to remove the binders and consolidate the metal particles into a solid metal structure. The first step in this process is typically debinding, which involves removing the binder from the metal particles. This is typically done through chemical methods, depending on the type of binder used. Typically debinding is achieved using catalytic debinding. In this process, the three-dimensional/3D metal printed part is immersed in a debinding fluid which is maintained at a temperature to produce vapours of the debinding fluid which facilitate debinding. A fluid which helps debinding is used as per the nature of the bond of the polymer. The debound part then undergoes a sintering process, which is essential for achieving full-density metal parts. In the sintering process, the brown part is heated to a high temperature, causing the metal particles to fuse together, creating a fully dense metal part.

The present invention provides a novel method for desktop three-dimensional (3D) metal printing that eliminates the need for a separate debinding process, thereby reducing process lead time, the risk of a damaged brown part and associated costs.

Conventionally, the debinding process involves immersing the part in a debinding solution followed by drying the part, which can take hours. The debound part also called “the brown part” which is susceptible to damage due to the loose retention of metal powders is then placed in a high-temperature furnace, in an inert environment to thermally degrade any remaining binder in the brown part before sintering.

However, this new process integrates debinding, sintering, and heat treatment into a single operation in a single piece of equipment, thus reducing the overall process lead time. To achieve this objective, a NOVEL material mixture (compositions) has been formulated, which includes but is not limited to metal powder and/or a mixture of metal powder and reinforcement of any kind (such as but is not limited to ceramic powder, graphite powder, nanomaterial, micromaterial, alloy powder.), inorganic compounds and/or organic compounds such as but is not limited to thermoplastic polymers and/or thermoplastic elastomers and/or thermosetting polymers as a binder(s), long chain fatty acids, and olefinic waxes. The long-chain fatty acids used in the material mixture can be any suitable fatty acid, such as but not limited to calcium stearate, stearic acid, behenic acid, or palmitic acid. The binder material in the mixture can be completely thermally degraded using a single thermal cycle in a piece of heating equipment, such as but not limited to a furnace, oven, heating coil, heat exchanger, etc., with a controlled environment before sintering the “brown part” in an inert environment. The residual brown part that remains inside the heating equipment, such as but not limited to a furnace, oven, heating coil or any other suitable piece of heating equipment, is then sintered and heat treated in a controlled environment to prevent oxidation of the metal parts in the very same thermal cycle. This approach effectively streamlines desktop 3D metal printing to a two-step process: (1) printing and (2) debinding, sintering, and heat treatment in a single-step process using a single piece of heating equipment.

In one embodiment, at least but not limited to two or more processes taking place in a single cycle. In an example of the embodiment, the debinding, sintering and heat treatment will take place in a single process. In the first phase, the green part is kept inside a piece of heating equipment such as but not limited to the furnace, debinding oven, heat exchanger or any other equipment raised to a degrading or debinding temperature of around 450 degrees Celcius at a constant or variable heating rate such as but not limited to 20 degrees Celcius per minute. The green part at around this temperature wherein the binder(s) starts to completely thermally degrade, hence forming the brown part. The green part is held at a constant debinding temperature for a time period also referred to as the holding temperature, until all the binders have completely thermally degraded and have formed a brown part. This could depend on but not be limited to the size and mass of the green part. The green part could be completely thermally debound in the presence of but not limited to oxygen gas, vacuum, and endothermic gases such as but not limited to Hydrogen gas and/or Nitrogen gas and/or Carbon monoxide gas. The heating chamber is vacuumed and/or flushed with endothermic gases to eliminate any unnecessary gases in the heating chamber once complete thermal degradation is successful. The flow rate could be around but not restricted to 1 Lt/mm3 to 15 Lt/mm³. An example, the hold time could be around 45 minutes at around 450 degrees Celcius in an atmosphere of oxygen and/or vacuum and/or endothermic gases. Once the brown part is formed, the heating chamber is partially flushed with a mixture of Hydrogen gas and/or, Nitrogen gas and//or Argon gas.

The second phase is ramping of the heat wherein the ramp rate refers to the heating rate in the heating chamber of the piece of heating equipment, measured in degrees Celsius per minute, may be but is not limited to constant or varying at an appropriate temperature. This depends on the physical properties of the material of the primary metal material mixture. In an example of this embodiment, the ramping rate could be at but not limited to 10 degrees Celcius per minute. The second phase is the sintering wherein the metal particles atomically diffuse into each other, the temperature will be raised in accordance with the sintering window of the material of the brown part. An example is but not limited to Stainless Steel 316 L getting sintered at around 1380 degrees Celcius. The brown part at around this temperature wherein the brown part starts sintering, hence forming a fully dense metal part. The brown part is held at a constant sintering temperature for a time period also referred to as the holding temperature, until a fully dense metal part is formed. This could depend on the physical properties of the metal in the primary metal material mixture. An example is but is not limited to the sintering temperature of 1380 degrees Celcius for Stainles Steel 316 L, and the sintering temperature of 990 degrees Celcius for Copper. The brown part could be completely sintered in the presence of but not limited to oxygen gas, vacuum, and endothermic gases such as but not limited to Hydrogen gas and/or Nitrogen gas and/or Carbon monoxide gas to avoid oxidation. The fully dense sintered metal part is not limited to cooling naturally. It could also be but not limited to cooled naturally until around 900 degrees Celcius and then cooled rapidly. The cooling cycle could be according to the microstructure requirement, which could be pre-fed into the system that could be selected as per requirement. The brown part could shrink after sintering into a fully metal part. The shrinking is adjusted by default when the CAD is sliced. The shrinkage could be non-uniform throughout the geometry, shrinking around almost equally in X & Y axes while shrinking more in the Z axes due to the force of gravity.

An appropriate example of this embodiment is a CAD file sliced in Thinkware for 3D printing. The necessary actions are taken by the software and the printer is instructed to print the necessary green part. The software generates a set of codes that instruct the machine to move back and forth in the XY plane, heat the extruder, extrude the primary metal material mixture filament from the nozzle, move the build platform or the bed to deposit the molten primary metal material mixture filament layer by layer, and other necessary tasks. Necessary support structures if required are also 3d printed along the green part. The part is 3d printed in Stainoless Steel 316 L material mixture filament. Once the green part is printed the green part is taken out of the 3d printer. It is then kept inside the furnace. Inside the heating chamber of the furnace, which could be but is not limited to being made out of metal and/or quartz and/or ceramic and/or graphite. Once, the green part is placed in the furnace, it is then heated to around 450 degrees celsius in around an hour at a rate of about 10 degrees Celcius per minute and a mixture of Nitrogen and/or Hydrogen and/or Argon gases are flushed into the heating chamber to eliminate any unnecessary gases in the heating chamber. The green part is held at this temperature for about an hour until all the binders are completely thermally degraded and a brown part is yielded. The heating chamber is vacuumed and/or flushed with a mixture of Nitrogen and/or Hydrogen and/or Argon gases are flushed into the heating chamber to eliminate any unnecessary gases in the heating chamber. Now, the heating chamber ramps up to the sintering temperature in around an hour to about 1380 degrees Celcius (sintering temperature for SS 316L) and holds the temperature for about a few hours typically but not restricted to 2 hours in the presence of a vacuum and/or endothermic gases and/or a mixture of Nitrogen and/or Hydrogen and/or Argon gases. Once, sintered we have a fully dense metal part. The heating chamber is cooled naturally. It could also be cooled naturally until around 900 degrees Celcius and then rapidly cooled. Once, completely cooled the part can be taken out of the furnace.

In an additional embodiment, a method is provided for producing a fully dense metal 3D-printed part by completely thermally degrading the binder material in the mixture through an appropriate thermal cycle. The method involves subjecting the mixture comprising the binder material and metal powder to a piece of heating equipment, such as but not limited to a debinding oven or a binder burnout furnace, to completely thermally degrade the binder material. The resulting material is then subjected to a sintering process in a piece of heating equipment, such as but not limited to a furnace, oven, heating coil, heat exchanger, etc., in a controlled environment to yield a fully dense metal 3D printed part. Once the fully dense metal part is produced, it is then subjected to a heat treatment process to relieve any and all residual stresses in the metal part. The heat treatment process can be performed in any suitable heating equipment, such as but not limited to a furnace, oven, heating coil, heat exchanger, etc. The resulting fully dense metal 3D printed part produced by the method described herein is of high quality and exhibits excellent mechanical properties. The method is advantageous in that it allows for the production of complex metal parts with intricate geometries that cannot be achieved by conventional manufacturing techniques.

In yet another additional embodiment concerning a novel material mixture comprising metal powder and/or a combination of metal powder and reinforcements, including ceramic powder, graphite powder, nanomaterials, micromaterials, alloy powder, inorganic compounds, and/or organic compounds such as thermoplastic polymers and/or thermoplastic elastomers and/or thermosetting polymers as binders, long chain fatty acids, and olefinic waxes. The composition of the material mixture is customized to meet specific design and engineering requirements, such as strength, durability, and heat resistance. The addition of reinforcements can selectively enhance the mechanical properties of the metal parts produced by 3D printing. Long-chain fatty acids, such as calcium stearate, stearic acid, behenic acid, or palmitic acid, could be used as lubricants to reduce friction and prevent wear and tear on the printer's nozzle during the printing process and allow for easy mixing of the metal powder and the reinforcement material. Long-chain fatty acids and olefinic waxes could also be added to the mixture to improve the flowability of the material mixture. Moreover, this embodiment provides a single-step process for producing metal parts. The process involves printing the desired object using the material mixture and then subjecting it to a single thermal cycle to thermally degrade the binder material, sinter and heat treat the “brown part” in an inert environment. This process reduces the production time and cost of 3D printing metal parts by eliminating the need for multiple steps, such as debinding, sintering, and heat treatment. This embodiment introduces a novel material mixture for 3D printing metal parts, offering improved mechanical properties selectively and a simplified production process.

The integration of debinding, sintering, and heat treatment in a single operation is achieved through the use of a novel material mixture. This material mixture may be extruded into filaments or rods and used as a feedstock in a desktop 3D metal printer. One of the challenges of metal 3D printing through Fused Filament Fabrication (FFF) or metal material extrusion or metal material deposition technology is the dire need for metal particles to be uniformly dispersed throughout the filament, in order to maintain consistent properties and quality of the printed object.

To ensure that the metal particles are evenly dispersed throughout the filament and that the printed object has consistent properties and quality, metal powders are frequently mixed with the binder material. This process is referred to as compounding, and it involves melting the base material and blending it with the metal powders prior to extruding it into filament form. During the compounding process, the metal powders are thoroughly mixed with the base material in a controlled environment to ensure uniform distribution. The metal powder(s) and/or alloy powder(s) and/or ceramic powder(s) and/or graphite powder are chosen based on their desired properties, such as but not limited to strength, conductivity, or corrosion resistance, and they are mixed in precise proportions to achieve the desired characteristics of the final product.

In one embodiment, the material mixture; is the binder material blend with the metal powder(s) and/or alloy powder(s) and/or ceramic powder(s) and/or graphite powder in a piece of equipment such as but not limited to twin screw extruder, and/or single screw extruder and/or blender and/or pelletizer and/or in any combination is used to compound the material mixture. During the compounding process, the metal powders are thoroughly mixed with the binder material in a controlled environment to ensure uniform distribution. By using compounding to mix the metal powders with the binder material, the resulting filament is more uniform in composition, which allows for more consistent properties and better quality in the printed object.

Once the metal powders and binder material have been thoroughly mixed, the resulting compound is pelletized. Pelletization is the process of forming small, uniform pellets or granules from a material. The process involves compressing the compounded material mixture into a small, dense pellet or granule. The compounded mixture is then fed into a pelletizer, which uses but is not limited to a rotating drum and/or twin screw extruders and/or another mechanism to compress the material into small pellets or granules. As the material passes through the pelletizer, it is subjected to pressure and friction, which helps form the pellets. The size and shape of the pellets can be controlled by adjusting the speed of the pelletizer and the size of the openings in the drum.

Once pelletized it is then extruded through a small opening to form a filament of uniform diameter. It is essential that the filament diameter is uniform to ensure uniform deposition of metal material mixture. This process of extrusion may be done using but is not limited to a twin screw extruder and/or single screw extruder and/or any other piece of equipment that essentially forms filaments of metal material mixture. One method for achieving uniform filament size is to manipulate extrusion speed and/or adjust pulling force, and/or vary nozzle diameter. The implementation of these techniques assures uniformity in filament size. The filament is then cooled in but not limited to an aqueous bath and wound onto a spool. It is now ready for use in the metal deposition 3D printing process.

In an additional embodiment of the invention, the material mixture comprises a binder material blend in combination with one or more types of metal powder(s) and/or alloy powder(s) and/or ceramic powder(s) and/or graphite powder. This material mixture is compounded within a controlled environment to ensure that the powder components are uniformly distributed. The compounding process takes place in a single piece of equipment or a combination of multiple pieces of equipment. The resulting mixture is then directly extruded to form a dense, uniformly distributed metal mixture filament. The filament is subsequently cooled in a suitable medium, which may include but is not limited to an aqueous bath, and wound onto a spool for ease of handling. The resulting filament is now ready for use in the metal deposition 3D printing process. Yet an additional embodiment of the present invention includes using a binder material with a relatively smaller particle size compared to the metal powder, such that the binder material powder fills up the tetrahedral/octahedral spaces while being blended for a uniform mixture. The material mixture (composition) is then thoroughly compounded and extruded to produce metal filaments with uniform and consistent diameters.

Another embodiment of the invention involves the use of a material mixture consisting of a binder material blend combined with one or more types of metal powder(s) and/or alloy powder(s) and/or ceramic powder(s) and/or graphite powder. This mixture is prepared within a single piece of equipment or a combination of multiple pieces of equipment and is obtained in the form of dense uniform material mixture pellets. The dense uniform material mixture pellets can be extruded directly using a suitable apparatus, and the resulting molten material mixture can be deposited layer by layer on the build platform or bed. This process essentially creates the object using the material mixture pellets as the starting feedstock. A suitable setup for this purpose could include a screw extruder, such as a single screw extruder or a co-rotating twin extruder or a counter-rotating twin screw extruder or any other piece of equipment, mounted on the gantry as the print head. The print head moves back and forth along the X and Y axes, while the build platform or the print bed moves up and down along the Z axis, depositing the material in selective locations to build up the object layer by layer. This setup enables the production of complex structures with precision and accuracy, using the dense uniform material mixture pellets as the feedstock.

In another embodiment including a print head comprising one or more pieces of equipment mounted on the gantry of the 3D printer. The print head is capable of compounding a material mixture consisting of a binder material blend combined with one or more types of metal powder(s) and/or alloy powder(s) and/or ceramic powder(s) and/or graphite powder. This setup allows for direct deposition of the material mixture onto the build platform or bed layer by layer, eliminating the need to create pellets, filaments, or rods.

In one embodiment of the present invention, the material mixture(s) enable 3D printing of the metal material mixture at low temperatures. Specifically, in one example, the molten material mixture can be deposited in fine layers of around but not limited to 120 degrees Celsius. This low-temperature printing process has several advantages, including reduced energy consumption, less material degradation, and less thermal stress on the printed part.

In another embodiment, the material mixture(s) enable 3D printing of the metal material mixture at slightly higher temperatures. For example, the molten material mixture can be deposited in fine layers of around but not limited to 230 degrees Celsius. This slightly higher temperature printing process could have advantages such as faster printing speeds and better surface finish quality.

Additionally, in one embodiment, the environment/ambience is heated, and the ambient temperature is raised during the printing process. For example, the ambient temperature could be around but not limited to 70 degrees Celsius. The ambient temperature is dependent on the thermal conductivity of the material mixture(s). A material that has high thermal conductivity and is more prone to warping as it loses heat readily needs to be deposited at an elevated temperature to avoid warping. A heated printer chamber, therefore, facilitates better-printed parts. It is important to note that the selection of the printing temperature depends on several factors, including the material properties, the desired properties of the printed part, and the printing environment. The temperature should be carefully chosen to ensure that the printed part is of the desired quality and is scientifically sound. In conclusion, the present invention provides a versatile method for 3D printing metal parts using a material mixture(s) that can be printed at low temperatures or slightly higher temperatures, depending on the desired outcome. Moreover, the use of a heated printer chamber ensures better print quality by reducing warping and promoting good adhesion between the layers. The present invention provides a valuable contribution to the field of 3D printing of metal parts by providing a more efficient, cost-effective, and high-quality printing process.

In accordance with one embodiment, metal deposition 3D printing poses an additional challenge, which is to maintain a constant flow of metal-infused filament. Metal powders, due to their abrasive nature, can lead to damage to the printer nozzle, leading to blockages and other complications. To overcome this obstacle, customized nozzles with specific physical attributes have been developed. These attributes include high hardness, low coefficient of friction, low specific wear rate, and high thermal conductivity materials. For instance, Vanadium Carbide has been identified as an effective material to manage the hardness of metal filaments.

In one embodiment, the nozzle is optimized to deposit material of a layer height around ½ the diameter of the nozzle diameter. This is designed to ensure a smooth material flow, resulting in the best possible surface finish. For instance, if the nozzle diameter is 0.4 mm, a recommended layer height could be 0.2 mm. This embodiment enables the 3D printing process to produce high-quality parts that are visually appealing and meet precise dimensional requirements.

In another embodiment, the nozzle can also deposit material with a layer height of around ⅕ of the nozzle diameter. For example, a nozzle diameter of 0.4 mm could deposit material with layers as fine as 0.08 mm or 80 microns. This embodiment is designed to enable the 3D printer to produce parts with a higher level of detail, such as intricate geometric designs, without sacrificing print quality. The choice of layer height can have a significant impact on the quality and accuracy of 3D-printed parts.

In both embodiments, the nozzle's diameter and layer height is optimized to produce high-quality parts with a smooth surface finish and precise dimensional accuracy. These embodiments also allow for greater flexibility in selecting the appropriate layer height for a given print job, enabling the 3D printer to produce parts with varying levels of detail and complexity.

In yet another embodiment, the layer height could be set as a function of the material being deposited. The properties of the material mixture have a direct influence on the layer height. For example, a material that is more prone to warping or cracking could be deposited at a lower layer height to reduce the internal stresses in the material during the printing process. Also, a material that has high thermal conductivity and is more prone to warping as it loses heat readily could be deposited at a different layer height, resulting in better-printed parts. By adjusting the layer height according to the material properties, the present invention enables optimal printing conditions for a wide range of materials, resulting in high-quality and dimensionally accurate printed parts.

In another embodiment, it is recognized that the layer height is also influenced by the flow properties of the material mixture(s). When a material is deposited at a finer height, the likelihood of blockages or clogging of the nozzle increases. This can result in the printing process being interrupted, causing a halt in the printing process. It is therefore important to carefully consider the flow properties of the material mixture(s) and to adjust the layer height accordingly in order to achieve optimal printing results without causing interruptions or delays.

In one example, the nozzle is designed to operate at a temperature that is higher than the melting point of the metal powder, and its interior is coated with a wear-resistant material to prevent wear and tear and is manufactured with a specific diameter and an angled shape to optimize the flow of the metal-infused filament. Thus, this embodiment addresses the issue of maintaining a constant flow of metal-infused filament by developing a customized nozzle with specific physical properties, such as hardness and wear resistance. This can prevent blockages and other complications, ultimately leading to a more efficient and seamless 3D printing process.

In some embodiments, the components of the binder(s) are organic, thermoplastic polymers, which can be completely thermally degraded during the sintering process. The use of such polymers in the binder system provides several advantages. For example, thermoplastic polymers and/or thermoplastic elastomers are easily processable and can be melted and extruded to form filaments. Furthermore, incorporating thermoplastic polymers as binders can enhance the mechanical characteristics of the green part, thereby enabling safe handling of the green part without causing any harm.

In some embodiments of the present invention, the binder system for the 3D printing of metal parts includes organic thermoplastic elastomers that can be thermally degraded during the sintering process. One significant advantage is the ease of processing of the thermoplastic elastomers. Due to their low melting point and ease of extrusion, these materials can be melted and extruded to form filaments that can be wound onto a spool without breakage. Furthermore, incorporating thermoplastic elastomers as binders can enhance the mechanical properties of the filament, making it more flexible and easier to handle during the printing process. In addition to their ease of processing and improved mechanical properties, the use of thermoplastic elastomers as binders can also offer benefits in terms of the sintering process. During the sintering process, the binder material must be completely removed to ensure the integrity of the final metal part. The use of thermoplastic elastomers as binders ensures that the material can be completely degraded without the need for additional steps. This characteristic simplifies the overall production process, reducing the time and cost required for the production of high-quality metal parts.

In an additional embodiment of the invention, the binder(s) system used in 3D printing metal parts can comprise organic, thermosetting materials. Unlike the organic, thermoplastic elastomers described in the previous embodiment, which are melt-processable and can be easily extruded into filaments, thermosetting materials are cross-linked during the curing process and become insoluble and infusible. The use of thermosetting materials as binders in the metal-infused filament provides several advantages. For example, thermosetting materials can be cured at relatively low temperatures and have excellent adhesion properties. The cured binder is chemically resistant and mechanically stable, making it ideal for use in 3D printing applications where dimensional stability and chemical resistance are critical. In some embodiments, the thermosetting materials used in the binder(s) system may include but is not restricted to epoxy resins, phenolic resins, or silicone resins. These materials can be mixed with the metal powder and any desired reinforcements to form a paste-like material, which can be extruded through the printer nozzle and deposited layer-by-layer to form the desired metal part. During the printing process, the thermosetting binder(s) material is cured by heat, either during or after the deposition of the material. The curing process is triggered by the application of heat, which causes the thermosetting material to crosslink and become a rigid, infusible solid. This curing process is irreversible, which means that the cured binder(s) material cannot be melted or reprocessed. One advantage of using thermosetting materials as binders is that they can be cured at relatively low temperatures, typically in the range of 100-150° C. This allows the printed part to be removed from the printer bed and transferred to a separate piece of heating equipment such as but not limited to the furnace or an over or any other equipment for the debinding, sintering & heat treatment process. During debinding and sintering, the binder(s) material is completely removed and sintering the metal part, leaving behind a fully dense metal part with excellent mechanical properties. In some embodiments, the use of thermosetting materials as binders can also improve the mechanical properties of the printed part. For example, the cured binder(s) material can act as a reinforcing agent, improving the strength of the part required for handling. In addition, the use of thermosetting materials as binders can also improve the dimensional accuracy and surface finish of the printed part. Overall, the use of thermosetting materials as binders in 3D printing metal parts provides several advantages, including improved mechanical properties for handling, dimensional accuracy, and surface finish. The cured binder(s) material is chemically resistant and mechanically stable, making it ideal for use in applications where dimensional stability and chemical resistance are critical. Furthermore, the low curing temperatures allow the printed part to be transferred to a separate piece of heating equipment such as but not limited to the furnace or an over or any other equipment for the debinding, sintering & heat treatment process providing a versatile and efficient 3D printing process for producing metal parts.

According to the embodiment of the present invention, the process comprises a sinterable composition which will comprise any sinterable material and a thermally degradable binder system. In many embodiments, the sinterable material can be but is not limited to metal powder and/or metal alloy powder and/or reinforcement powder and/or graphite powder etc. In some embodiments, the reinforcements can be but are not limited to nanomaterial, ceramic powder etc. The binder system comprises binder(s) and lubricant(s) in variable percentages by volume. Long-chain fatty acids, such as calcium stearate, stearic acid, behenic acid, or palmitic acid, could be used as lubricants to reduce friction and prevent wear and tear on the printer's nozzle during the printing process and allow for easy mixing of the metal powder and the reinforcement material. Long-chain fatty acids and olefinic waxes could also be added to the mixture to improve the flowability of the material mixture.

In an additional embodiment, the apparatus comprises at least print head, each capable of extruding a primary metal material filament. This enables the creation of structures with different material properties in different parts of the object. For example, a part could be printed with a combination of high-strength metal and lightweight metal, allowing for both strength and weight savings in a single part. The ability to print with multiple primary metal materials in a single print head or multiple print heads also provides the ability to print metal parts with graded compositions could also be referred to as Functionally Graded Material (FGM), allowing for the creation of complex structures with varying material properties.

In both embodiments, the use of multiple metal material filaments presents some technical challenges. One such challenge is ensuring a consistent flow of both filaments during printing. In order to address this challenge, the apparatus could require specialized software and hardware, such as a custom-designed printer control board or software that can synchronize the movements of the two print heads or the switchable feeding mechanism in a single print head. Additionally, the use of multiple filaments may require adjustments to the printer's settings, such as nozzle temperature, print speed, and layer height, in order to achieve optimal printing results.

Another challenge is ensuring proper adhesion between the layers of different metal materials. In order to achieve a strong bond between layers, the printing process may require the use of specialized adhesion techniques, such as but not limited to the application of a metal bonding agent or the use of a laser to locally heat and fuse the layers together. In summary, the use of an apparatus that can extrude and deposit multiple metal materials in 3D printing can enable the creation of complex, multi-functional objects with tailored material properties. The use of two print heads or a turn-by-turn mechanism can provide faster printing times and the ability to print with more than two materials. However, the use of multiple filaments presents technical challenges that must be addressed through specialized software and hardware, as well as adjustments to the printing process itself.

Overall, the apparatus described in these embodiments provides a flexible and versatile solution for 3D printing metal parts, allowing for the deposition of multiple primary metal materials in a controlled and precise manner, and the creation of complex geometries with graded material properties.

In yet another aspect, the present invention relates to the use of multiple metal material filaments in a single print head or multiple print heads to enable the creation of complex geometries and deposition of metal parts with varying material properties. This ability to print metal parts with graded compositions is also referred to as Functionally Graded Material (FGM). In some embodiments, a metal material filament with a lower melting point than the sintering temperature of a second metal material filament may be printed in a single layer or in alternate layers or a combination of both. This facilitates liquid phase sintering and implied capillary action in the part during the sintering temperature of the second metal material, which enhances the density of the printed part. For example, copper and stainless steel can be used as the two metal materials. Copper has a lower melting point than the sintering temperatures of stainless steel, this will facilitate liquid phase sintering, and therefore, the copper material will be pulled into the gaps between the stainless steel particles by capillary action, resulting in an increase in the density of the printed part.

The binder material in the mixture can then be completely thermally degraded using a single thermal cycle in a piece of heating equipment, such as but not limited to a furnace, oven, heating coil, heat exchanger, etc., with a controlled environment before sintering the “brown part” in an inert environment. The residual brown part that remains inside the heating equipment, such as but not limited to a furnace, oven, heating coil or any other suitable piece of heating equipment, is then sintered in a controlled environment to prevent oxidation of the metal parts in the very same thermal cycle. This approach effectively streamlines desktop 3D metal printing to a two-step process: (1) printing and (2) debinding, sintering, and heat treatment in a single-step process using a single piece of heating equipment.

In one embodiment, a new mixture of materials can be created for use in 3D printing. This mixture can contain graphite powder and/or metal powders, and/or a combination of metal powders and/or alloy powders. Additionally, inorganic and/or organic compounds such as thermoplastic polymers and/or thermoplastic elastomers and/or thermosetting polymers can be included as binders. Long-chain fatty acids and olefinic waxes can also be part of the mixture.

The long-chain fatty acids utilized in the material mixture can be any appropriate type of fatty acids, such as but not limited to calcium stearate, stearic acid, behenic acid, or palmitic acid.

In 3D printing, support structures play a crucial role in facilitating the creation of complex geometries and aiding in the 3D printing of overhangs. The support material must be easily removable without requiring complex equipment, and it should not cause damage to the primary metal material during 3D printing, debinding, or sintering. In one embodiment of the present invention, graphite has been discovered to be an ideal support material due to its ability to fulfil the aforementioned properties. The new material mixture offers numerous advantages over conventional materials. The inclusion of graphite in the mixture as a support material makes the process of removing support structures easier and less time-consuming, which enhances the efficiency of the 3D printing process. Additionally, the mixture's use of a binder system containing inorganic and/or organic compounds improves its processability at lower temperatures, allowing for easier melting and extrusion of filaments without breakage.

An apparatus is disclosed that comprises at least two print heads, with one print head having the capability to deposit a primary metal material filament and the other print head having the ability to deposit graphite material layer by layer on the build platform or bed, to produce a support structure that facilitates the 3D printing of overhangs. The deposition of the two filaments could be done simultaneously or turn-by-turn. This allows for the creation of structures with internal and/or external overhangs, thereby making it possible to print more complex geometries.

In another embodiment, the apparatus comprises a single print head that can alternate between depositing the primary metal material and the support structure material as needed. This can be achieved through the use of a suitable mechanism, such as a switchable feeding mechanism. By depositing the appropriate materials turn-by-turn, the apparatus can create structures with greater complexity such as designs with internal and/or external overhangs.

The use of graphite as a support structure offers several key advantages. Graphite has low hardness, which means that the primary metal part being printed will not get damaged when the part is getting sintered. In addition, graphite has good thermal conductivity, which can help prevent warping or deformation of the primary metal part during the sintering process.

In an embodiment of the present invention, a method of printing a metal part using graphite as a base support material for good bed adhesion of the first layer of primary metal material is provided. In this embodiment, the first layer of the metal part is printed onto a build platform or bed made after a few layers of graphite are 3d printed. It is then followed by the deposition of the subsequent layers of the primary metal material mixture. This sequential deposition of the primary metal material atop graphite layers ensures that the metal part created atop does not warp under any circumstances, thus resulting in a more dimensionally stable part. This method also ensures good adhesion of the first primary metal material when deposited onto the build plate or bed, resulting in good dimensional accuracy and fewer failed 3d prints due to poor build plate or bed adhesion.

Moreover, the use of graphite as a base support material for good bed adhesion of the first layer of primary metal material allows for easy removal of the base support after the debinding and sintering stages without causing damage to the primary metal material. Additionally, graphite's low hardness and good thermal conductivity make it a suitable base support material for good bed adhesion of the first layer of the primary metal material for use in 3d printing metal parts. This could also enable the creation of efficient support structures with internal and/or external overhangs rising from the base support, making it possible to create complex geometries with high precision and accuracy.

In some embodiments, the graphite used for printing the first layer may be modified to include additives that enhance its properties. For example, graphite may be modified to have higher heat retention for better bed adhesion, which would result in even better dimensional stability of the final part. Alternatively, the graphite could be modified to have a higher coefficient of friction, which could improve the adhesion of the first primary metal layer to the build plate or bed.

In another embodiment, the printing process may involve the use of two print heads, one for depositing the primary metal material and the second for depositing the graphite support material either for the base or for the overhangs. The two filaments could be deposited simultaneously or turn by turn, enabling the creation of complex structures. In yet another embodiment, a single print head may alternate between depositing the primary metal material and the support material when needed, through the use of a suitable mechanism, such as a switchable feeding mechanism. This turn-by-turn deposition of the appropriate materials allows the apparatus to create structures with greater complexity as and when required.

The novel material mixture used in the support structure for but not limited to the base layer for the primary metal material and/or for internal and/or overhangs 3D printing process comprises graphite powder, one or multiple metal powder(s), and/or a mixture of metal powder(s) and/or alloy powder, inorganic compounds and/or organic compounds such as but not limited to thermoplastic polymers and/or thermoplastic elastomers and/or thermosetting polymers as a binder(s), long chain fatty acids, and olefinic waxes. Suitable long-chain fatty acids include but are not limited to calcium stearate, stearic acid, behenic acid, or palmitic acid. The composition is blended thoroughly and extruded in a manner that results in graphite filaments with a consistent and uniform diameter.

In 3D printing, support structures play a significant role in the design of overhangs and the creation of complex geometries. It is crucial that the support material is easily removable without requiring the use of complex equipment. Furthermore, the support structure material must not damage the primary metal material during 3D printing and/or debinding and/or sintering. Graphite has been found to be highly suitable as a support material that satisfies these requirements.

In summary, the disclosed apparatus comprises at least two print heads, with one print head having the capability to deposit a primary metal material filament and the other print head having the ability to deposit graphite material layer by layer on the build platform or bed to create a support structure for 3D printing overhangs and/or a base support material for good bed adhesion of the first layer of primary metal material allowing for easy removal of the base support after debinding and sintering stages without causing damage to the primary metal material. The use of graphite as a support structure material offers several key advantages, including low hardness and good thermal conductivity. Additionally, the material mixture used in the support structure for but not limited to the base layer for the primary metal material and/or for internal and/or overhang 3D printing process comprises graphite powder, one or multiple metal powder(s) and/or a mixture of metal powder(s) and/or alloy powder, inorganic compounds and/or organic compounds such as but not limited to thermoplastic polymers and/or thermoplastic elastomers and/or thermosetting polymers as a binder(s), long chain fatty acids, and olefinic waxes. Overall, the embodiments described above offer several advantages over conventional 3d printing methods, including improved dimensional accuracy, enhanced support structure removal, and the ability to create complex geometries with high precision and accuracy. The support structures facilitate the creation of complex geometries, and the use of turn-by-turn deposition of the appropriate materials makes it possible to create structures with greater complexity such as designs with internal and/or external overhangs.

1. A three-dimensional printing method for a three-dimensional printing device, the three-dimensional printing device being configured to print a three-dimensional object, the three-dimensional printing method comprising:
(a) obtaining a plurality of sliced objects corresponding to a three-dimensional model of the three-dimensional object;
(b) obtaining printing information of the plurality of sliced objects;
(c) extrusion of a filament typically made of a unique feedstock mixture comprising of metallic powder, reinforcement, and a binder system with lubricating agents, through a heated nozzle and loaded in the 3D printer;
(d) driving a nozzle module according to the printing information to print the three-dimensional object controlled by an integrated software;
(e) integrating debinding, sintering and heat treatment of the three-dimensional object in a single heat equipment thereby reducing the overall process lead time.

2. The three-dimensional printing method as claimed in claim 1 wherein the feedstock mixture is prepared from a group comprising of metal powder, a mixture of metal powder and reinforcement, inorganic compounds and/or organic compounds.

3. The three-dimensional printing method as claimed in claim 2 wherein the reinforcement is selected from a group comprising of ceramic powder, graphite powder, nanomaterial, micromaterial and alloy powder.

4. The three-dimensional printing method as claimed in claim 2 wherein the organic compound is selected from a group comprising of thermoplastic polymers and/or thermoplastic elastomers as a binder(s), long chain fatty acids, and olefinic waxes.

5. The three-dimensional printing method as claimed in claim 1 wherein the unique composition is customized to meet specific design and engineering requirements, such as strength, durability and heat resistance.

6. The three-dimensional printing method as claimed in claim 1 wherein the feedstock mixture further includes long-chain fatty acids to reduce friction and prevent wear and tear on the printer's nozzle.

7. The three-dimensional printing method as claimed in claim 6 wherein the long-chain fatty acids is selected from a suitable fatty acid including calcium stearate, stearic acid, behenic acid or palmitic acid.

8. The three-dimensional printing method as claimed in claim 1 wherein the heating equipment is a furnace, oven, heating coil or heat exchanger.

9. A three-dimensional printing device for printing a three-dimensional object, the three-dimensional printing device comprising:
(a) a nozzle module disposed on the three-dimensional printing device;
(b) a controller coupled to the nozzle module; and
(c) a processor coupled to the controller, the processor is configured to obtain a plurality of sliced objects corresponding to a three-dimensional model of the three-dimensional object,
(d) the processor is further configured to obtain printing information of the plurality of sliced objects,
(e) the processor is further configured to determine an top surface area of the three-dimensional object according to the printing information,
(f) the processor is further configured to obtain first printing information of the top surface area in the printing information, and
(g) the controller is configured to drive the nozzle module according to the printing information to print the three-dimensional object, wherein in the process of printing the three-dimensional object,
(h) the controller is further configured to drive the nozzle module to move above the top surface area again according to the first printing information to heat a plurality of printing materials located on the top surface area after the top surface area is printed.

10. A three-dimensional printing device for printing a three-dimensional object as claimed in claim 9 further comprising at least two print heads wherein one print head with a capability to deposit a primary metal material filament and the other print head with a ability to deposit graphite material layer by layer on the build platform or bed to create a support structure for 3D printing overhangs and/or a base support material for good bed adhesion of the first layer of primary metal material allowing for easy removal of the base support after debinding and sintering stages without causing damage to the primary metal material.
